(19) United States
(12) Patent Application Publication
(10) Pub. No.: US 2009/0263440 A1
(43) Pub. Date: Oct. 22, 2009

(54) DISPOSABLE CONTAINERS AND UTENSILS FOR SANITIZING

(76) Inventor: Yvette Kathrynn Kendall, Matteson, IL (US)

Correspondence Address: Yvette;Kendall, P.O. BOX 2333, Matteson, IL, 60443, US

(21) Appl. No.: 12/427,129

(22) Filed: Apr. 21, 2009

Related U.S. Application Data
(60) Provisional application No. 61/047,023, filed on Apr. 22, 2008.

(51) Int. Cl. A01N 25/34; A01P 1/00

(52) U.S. Cl. 424/412; 424/411

(57) ABSTRACT

A disposable container and/or utensil including an uncoated portion and a coated portion. The coated portion includes antibacterial agents and covers a substantially larger external surface area of the disposable container than the uncoated portion. The coated container includes, but is not limited to, a cup, a cup sleeve, or a food container.

### CROSS REFERENCE TO RELATED APPLICATIONS

The present application claims the benefit of U.S. Provisional Application No. 61047023, filed Apr. 22, 2008.

### FIELD OF THE INVENTION

The present invention generally relates to the field of disposable container and utensil design and hand sanitization.

### BACKGROUND OF THE INVENTION

Communicable diseases and viruses are a major health concern in the United States and in other countries. Many of these diseases and viruses are caused by bacteria found on everyday objects. Pathogenic bacteria may only comprise a small percentage of the total bacteria that can adversely affect the health of human beings. Year round but especially in the cooler months, infections caused by pathogenic bacteria can spread through populated areas of the country and the world. Many of these infections are fairly minor in nature and are generally just a nuisance (e.g., the flu or common cold). Their only major impact is that the infected person must deal with one or more symptoms including sneezing, coughs, sore throat, weariness, fever, congestion, and ear infections. While these symptoms may not be life threatening, they do often prompt the infected person to take cold and pain medication to ease the symptoms. These medications have side-effects of their own. People who refrain from using them have no other recourse but to suffer through the infection.

Examples of more serious, particularly pernicious pathogenic bacteria include Campylobacter jejuni (causing food poisoning), Enterococcus faecalis, Escherichia coli (E. Coli), Staphylococcus aureus (causing Staff infections), and Streptococcus (causing strep throat). While these diseases are not always life-threatening to normal, healthy adults, these infections can become deadly to the sick, the elderly, or the young.

While most types of bacterial infections can be treated with antibiotics, this remedy is not without costs. Antibiotics can be expensive and most can only be procured with a prescription given by a doctor after a physical examination performed during a doctor's visit. Unfortunately, antibiotics take time to work which means that the patient will have symptoms for several days at least after starting treatment.

Therefore, the best way of handling infections from pathogenic bacteria is to prevent their outbreak and spread. Preventative measures can take several forms but center around eliminating the spread of the actual physical bacteria. Since one of the more important ways bacteria enters the body is through the mouth, it is quite important for people to keep their hands free of pathogenic bacteria. This is especially true when an individual is preparing to eat or drink using various food containers and utensils. For some time now antibacterial soaps have been available to the public. While these soaps can certainly be effective, they are only effective when used immediately prior to the handling of food.

People often forget to wash their hands and do not have antibacterial soap available. Further, children may refuse to wash their hands or not wash their hands thoroughly prior to consuming foods or beverages. Some approaches to remedying these problems include placing antibacterial agents on disposable napkins or paper towels. While this approach has the advantage of being more portable than a soap bottle, it still has one major disadvantage: people often forget to use the hygienic napkins or do not always have them available when they need them. People may also view the use of the napkins themselves as a nuisance and not use them even when presented to them.

What is needed is a system and method of dispensing antibacterial agents effectively that is unobtrusive to the users and easy to implement. What is also needed is a way of dispensing antibacterial agents to the hands of users before they eat for maximum effectiveness at preventing the ingesting of pathogenic bacteria. What is further needed is a method for dispensing antibacterial agents that can be used by all members of society including children.

### SUMMARY OF THE INVENTION

In overcoming the above disadvantages associated with present techniques for preventing the spread of pathogenic bacteria, a disposable container and/or utensil, in accordance with the present invention includes, but is not limited to, a container and/or utensil including an uncoated portion and a coated portion. The coated portion includes antibacterial agents and covers a substantially larger external surface area of the disposable container than the uncoated portion. The coated container includes, but is not limited to, a cup, a cup sleeve, or a food container.

In accordance with an aspect of the invention, the uncoated portion comprises substantially less antibacterial agents than the coated portion.

In accordance with a further aspect of the invention, the antibacterial agents of the coated portion respond to pressure, including friction.

In accordance with another aspect of the invention, the antibacterial agents of the coated portion respond to temperature, including body-heat.

In accordance with yet another aspect of the invention, the antibacterial agents are released from the coated portion of the disposable container and/or utensil when agitated.

In accordance with a further aspect of the invention the coated portion is selectively positioned on the disposable container and/or utensil, such that only graspable areas of the disposable container and/or utensil are covered with the antibacterial agents of the coated portion.

### DESCRIPTION OF THE DRAWINGS

Preferred and alternative examples of the present invention are described in detail below with reference to the following Figure drawings:

FIG. 1A illustrates a perspective view of a disposable cup container in accordance with an embodiment of the present invention;

FIG. 1B illustrates a perspective view of a disposable cup sleeve in accordance with an embodiment of the present invention;

FIG. 2 illustrates a cross section view of a disposable medium in accordance with an embodiment of the present invention;

FIG. 3 illustrates a perspective view of disposable utensils in accordance with an embodiment of the present invention;

FIG. 4 illustrates a perspective view of a disposable food container in accordance with an embodiment of the present invention; and

FIG. 5 illustrates a flow diagram of a sanitizing process in accordance with an embodiment of the present invention.

### DETAILED DESCRIPTION

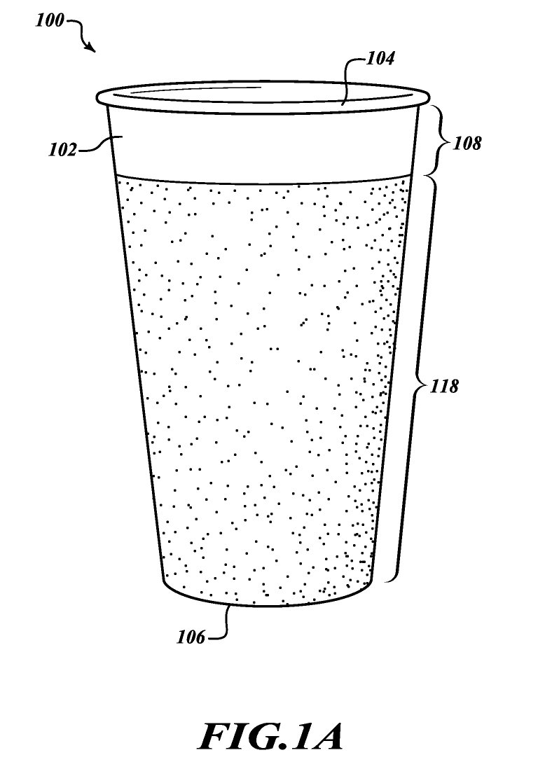

In accordance with an exemplary embodiment of the present invention, FIG. 1A illustrates a cup 100 coated with an antibacterial agent. The cup is made out of a disposable material. The cup can be made out of any disposable material known in the art including but not limited to plastics, cardboard, paper (including wax coated paper), and Styrofoam. The exterior of the cup 102 is generally the area where a person grasps or handles the cup. While the present embodiment does not show any markings on the exterior of the cup, the invention is not so limited; the exterior of the cup can have markings including graphics, pictures, text, and other markings well known in the art. These markings may be aesthetic in nature and may include the marque or brand of a company (e.g., markings associated with a logo or trademark). The exterior may also be translucent or opaque.

The cup exterior, as illustrated, has two distinct portions: an uncoated section or portion 108 which is not treated with the antibacterial agent and a coated section or portion 118 that is treated with the antibacterial agent. In the present embodiment, the untreated section has no antibacterial agent. In other embodiments, the untreated areas may actual include some agent, just a lesser dosage. In other embodiments the entire cup exterior may include the antibacterial agent. The cup also includes a bottom portion 106 that may or may not be treated with an antibacterial agent. The interior of the cup 104 is generally not treated with the antibacterial agent as this portion of the cup is typically not handled by a person's hands.

In FIG. 1A the treated area of the cup is larger than the untreated area. However, the present invention is not so limited, and in some cases, the untreated area may be larger than the treated area. Furthermore, the illustration of the exemplary embodiment shows a uniform distribution of the antibacterial agent in the treated portion of the cup. The present invention is not so limited. In the treated region of the cup, the antibacterial agent may be applied in higher dosages in certain areas and in lower dosages in others. In fact, the present invention embraces any distribution of the antibacterial agent in the graspable and non-graspable areas of the cup that facilitates the elimination of bacteria from the hands of the user and lessens the chance of the user ingesting harmful bacteria.

FIG. 1B illustrates a cup sleeve 150 coated with an antibacterial agent in accordance with an exemplary embodiment of the present invention. The exterior 152 of the sleeve comprises two portions: and uncoated portion 158 and a coated portion 160. The coated portion of the cup sleeve is treated with an antibacterial agent while the uncoated portion is not treated with an antibacterial agent. The bottom of the sleeve 156 is left untreated in the present embodiment. In another embodiment of the present invention, the bottom of the sleeve may be treated with an antibacterial agent. The interior of the sleeve 154 is generally not treated with an antibacterial agent. The cup sleeve 150 is made out of a disposable material know in the art, including, but not limited to plastics, cardboard, paper, wax paper, and Styrofoam.

FIGS. 1A and 1B illustrate two related embodiments in accordance the present invention. The present invention is not limited to these two designs. In other embodiments of the present invention, the cup or sleeve may include handles. These handles may also be coated with an antibacterial agent. The density or dosage of the antibacterial agent may vary; it may be more than, less than, or equal to the density or dosage of the antibacterial agent found in other coated areas of the cup or sleeve. The cup may also include a lid. In an embodiment of the present invention, all or a portion of the lid may be coated with an antibacterial agent. In an alternate embodiment, the lid is not treated with an antibacterial agent. The lid may or may not be made out of the same material as the sleeve or cup. The sleeve or cup can be designed for hot liquids, cold liquids, or both, including insulative properties allowing the liquids to retain their temperature for extended periods of time.

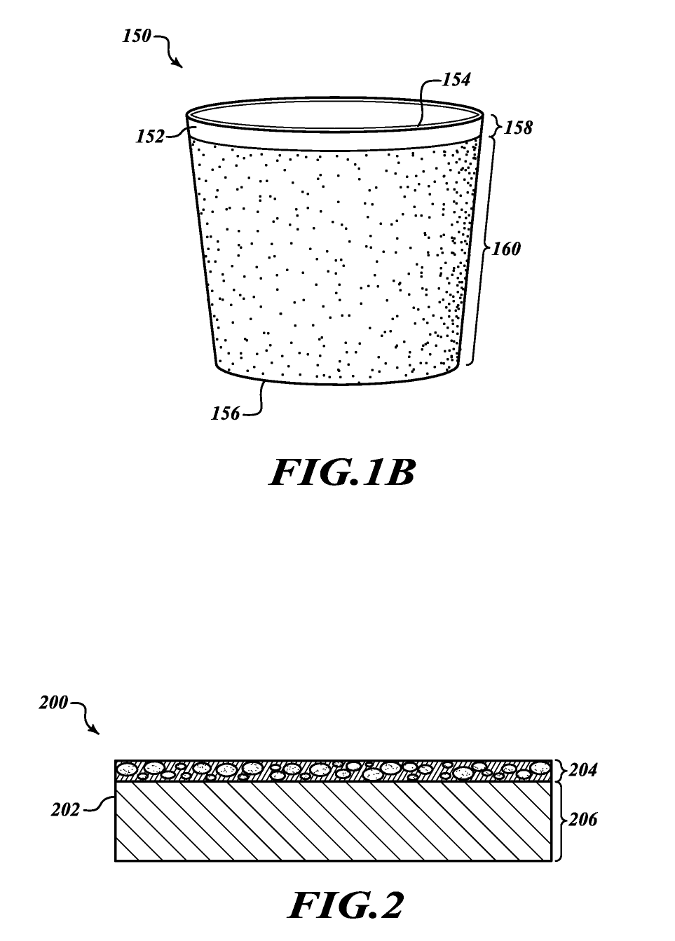

FIG. 2 illustrates a cross section 200 of the material 202 used to fabricate the disposable containers and/or utensils of the present invention. The material 200 generally includes two main portions or sections. The uncoated section 206 is the thickest part of the cross section. It includes the main material that is rigid and gives the container or utensil its form. This material typically is nonporous. In an embodiment of the present invention, it also may serve as an insulator. As previously mentioned, this material can be any disposable material known in the art including but not limited to plastics, cardboard, paper, wax paper, and Styrofoam. In certain embodiments, all or part of this material may include dyes or other chemical additives. The coated section 204 in the present embodiment is much thinner and contains the antibacterial agent, which may include any common alcohol or non-alcohol based hand sanitizer agents, including any well known encapsulated antibacterial agents. In an embodiment of the present invention, this section 204 may include other inert additives that do not hinder the effect of the antibacterial agent. In embodiments of the present invention, these additives may serve as adhesive or may include dyes that contribute to the design of the container or utensil.

FIG. 2 shows an embodiment of the present invention of the present invention wherein the antibacterial agent is a separate region affixed to main material of a utensil or container by any well known chemical bonding or coating process. This embodiment has several advantages. In certain processes, or for certain products, it may allow the antibacterial agent to be applied before or after the manufacturing of a disposable product is complete. Also, this configuration ensures that the antibacterial agent is only used on portions of the material where the user would touch the material thereby maintaining the effectiveness of the invention without wasting the antibacterial agent. Of course, other embodiments are envisioned by the invention. The antibacterial agent may be substantially mixed or encapsulated within a main material as opposed to being applied as a layer to the main material. Also, the antibacterial agent may be coated on the main material at any time during a fabrication process.

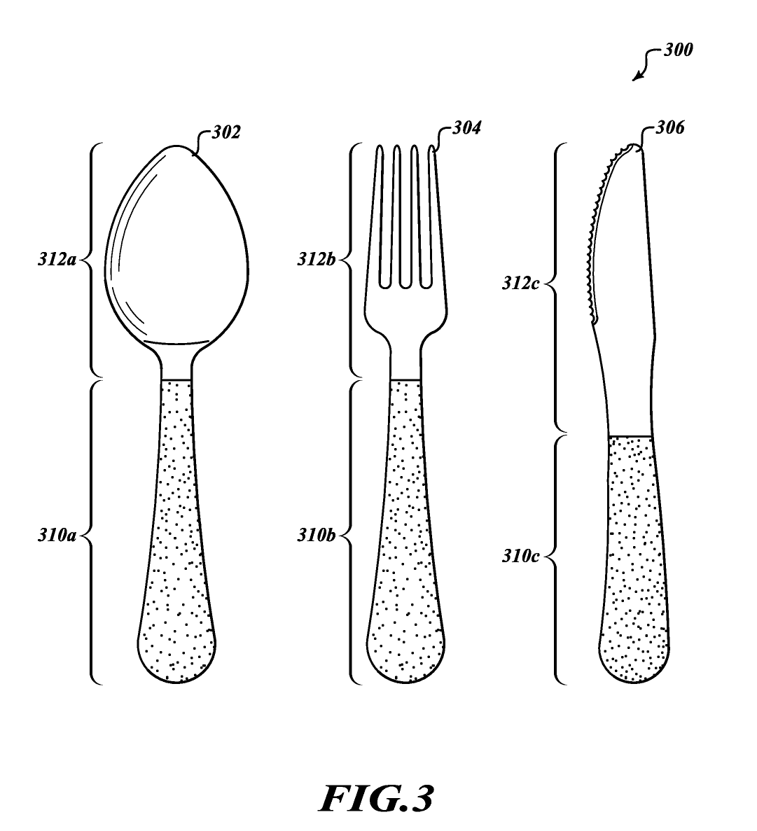

FIG. 3 illustrates three utensils 300 made in accordance with an embodiment of the present invention. The spoon 302 illustrated in this figure has two regions. The first region 312a includes the head of the spoon and is not treated with an antibacterial agent. The second region 310a includes most of the handle and is treated with an antibacterial agent. The fork 304 illustrated in this figure also has two regions. This region 312b includes the tines of the fork as well as part of the handle and is not treated with an antibacterial agent. Region 310b includes most of the handle of the fork and is treated with an antibacterial agent. The knife 306 includes to main regions. The first region 312c includes the blade and some of the handle and is not treated with an antibacterial agent. The second region 310c includes most of the handle and is treated with an antibacterial agent.

In other embodiments consistent with the present invention, the proportions between the treated and untreated portions of the utensils may be altered. Also, in the present figure the treated area of the utensils contains a uniform distribution of the antibacterial agent but the invention is not so limited. The treated regions of the utensils may have non-uniform distributions of the antibacterial agent. The utensils can be made out of any disposable material including but not limited to plastics and paper and cardboard products. In an embodiment of the present invention, the utensils may also include markings, pictures, or graphics. These may include the brand name or logo of the manufacturer or dispenser of the utensils or a restaurant or vendor name. The utensils may be opaque or clear.

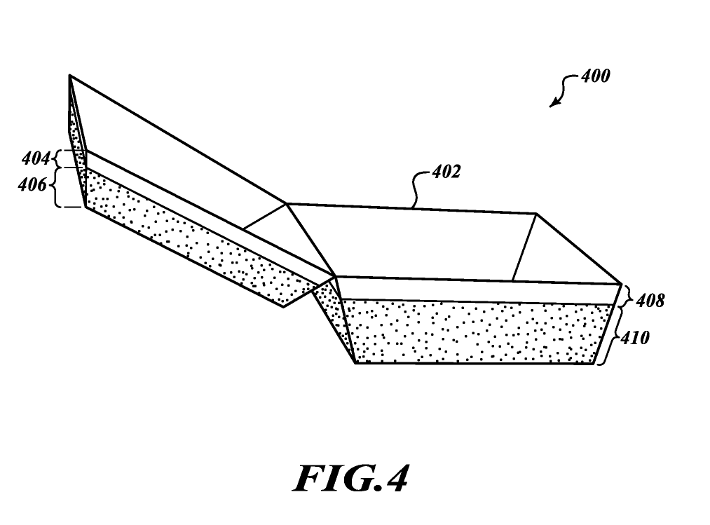

FIG. 4 illustrates a container 400 with portions coated with an antibacterial agent in accordance with an exemplary embodiment of the present invention. The container includes portions 404 and 408 of its exterior that are not coated with an antibacterial agent. The interior 402 of the container is generally not coated with an antibacterial agent. Certain portions 406 and 410 of the exterior are coated with an antibacterial agent. The present container is capable of holding a variety of foodstuffs including but not limited to hamburgers, sandwiches, chicken nuggets and French fries. The container may be large enough to hold a plate or a full menu. In an embodiment of the present invention, the container can have internal compartments of various sizes and configurations. The container can be made out of any disposable material designed to hold foodstuffs including but not limited to paper, wax paper, cardboard, plastics, or Styrofoam. In an embodiment, the container may also have markings on its interior and exterior that may include text, graphics, or pictures. These may include the brand name or logo of the manufacturer or dispenser of the container or a restaurant or vendor name. The container may be opaque or clear.

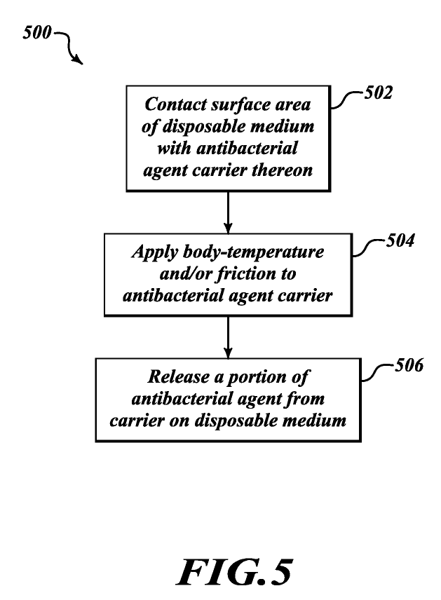

FIG. 5 illustrates a flowchart 500 depicting how the invention is used in an exemplary embodiment. The process starts with the user grasping the treated disposable product or medium. The user makes contact with the coated surface of the disposable product as shown in box 502. The user, while grasping the product, applies his body temperature or friction or a combination of both, to the treated area as shown in box 504. The treated portion of the product then releases a portion of the antibacterial agent from the disposable medium onto the user's hands thereby cleaning them of any bacteria once on the user's hands, as shown in box 506. In an embodiment of the present invention, the antibacterial agent can be activated by other means including pressure or oils in the user's skin.

While several embodiments of the present invention have been illustrated and described herein, many changes can be made without departing from the spirit and scope of the invention. Accordingly, the scope of the invention is not limited by any disclosed embodiment. Instead, the scope of the invention should be determined solely from the appended claims that follow.

The embodiments of the invention in which an exclusive property or privilege is claimed are defined as follows:

1. A disposable container comprising:
an uncoated portion; and
a coated portion,
wherein the coated portion covers a substantially larger external surface area of the disposable container than the uncoated portion, and
wherein the coated portion comprises antibacterial agents.

2. The disposable container of claim 1, wherein the uncoated portion comprises substantially less antibacterial agents than the coated portion.

3. The disposable container of claim 1, wherein the antibacterial agents of the coated portion respond to pressure, including friction.

4. The disposable container of claim 1, wherein the antibacterial agents of the coated portion respond to temperature, including body-heat.

5. The disposable container of claim 1, wherein the antibacterial agents are released from the coated portion of the disposable container when agitated.

6. The disposable container of claim 1, wherein the coated portion is selectively positioned on the disposable container, such that only graspable areas of the disposable container are covered with the antibacterial agents of the coated portion.

7. A disposable utensil comprising:
an uncoated portion; and
a coated portion,
wherein the coated portion covers a substantially larger external surface area of the disposable utensil than the uncoated portion, and
wherein the coated portion comprises antibacterial agents.

8. The disposable utensil of claim 7, wherein the uncoated portion comprises substantially less antibacterial agents than the coated portion.

9. The disposable utensil of claim 7, wherein the antibacterial agents of the coated portion respond to pressure, including friction.

10. The disposable utensil of claim 7, wherein the antibacterial agents of the coated portion respond to temperature, including body-heat.

11. The disposable utensil of claim 7, wherein the antibacterial agents are released from the coated portion of the disposable utensil when agitated.

12. The disposable utensil of claim 7, wherein the coated portion is selectively positioned on the disposable utensil, such that only graspable areas of the disposable utensil are covered with the antibacterial agents of the coated portion.

13. A method of using a disposable medium to sanitize, comprising:
contacting a surface area of the disposable medium;
affecting a coated surface of the disposable medium; and
releasing antibacterial agents from the coated surface of the disposable medium to sanitize an affecting object.

14. The method of claim 13, wherein the disposable medium is a disposable container.

15. The method of claim 13, wherein the disposable medium is a cup.

16. The method of claim 13, wherein the disposable medium is a disposable utensil.

17. The method of claim 13, wherein the affecting object affects the coated surface area by applying pressure, including friction.

18. The method of claim 13, wherein the affecting object affects the coated surface area by applying temperature, including body-heat.

19. The method of claim 13, wherein the antibacterial agents are released from the coated portion of the disposable medium when affected.

20. The method of claim 13, wherein the coated portion is selectively positioned on the disposable medium, such that only graspable areas of the disposable medium are covered with the antibacterial agents.
